(19) United States
(12) Patent Application Publication
(10) Pub. No.: US 2026/0365559 A1
(43) Pub. Date: Nov. 19, 2026

(54) OPTICAL FIBER PREFORM

(71) Applicant: Shin-Etsu Chemical Co., Ltd., Tokyo (JP)

(72) Inventor: Yuhei URATA, Ibaraki (JP)

(21) Appl. No.: 19/676,764

(22) Filed: May 13, 2026

(30) Foreign Application Priority Data
May 16, 2025 (JP) 2025-082555

(51) Int. Cl. C03B 37/018

(52) U.S. Cl. CPC C03B 37/018

(57) ABSTRACT

Provided is an optical fiber preform including a core portion with a relatively high refractive index and a cladding portion with a relatively low refractive index, in which in a luminance distribution of transmitted light projected, when laser light is incident on the optical fiber preform to be scanned in a radial direction of the optical fiber preform from one end to another end, on a screen or on a line sensor camera installed to face a light source of laser light with the optical fiber preform interposed therebetween, a width of a luminance distribution exceeding a set luminance threshold does not exceed a set width threshold.

### BACKGROUND

### 1. Technical Field

The present invention relates to measurement of a refractive index profile of an optical fiber preform to be produced into an optical fiber by being drawn.

### 2. Related Art

An optical fiber preform for communications includes the core portion having a high refractive index and the cladding portion having a relatively low refractive index on an outer periphery thereof. In the VAD method, which is one method for manufacturing a core glass rod constituted by a core portion and a part of a cladding portion of the optical fiber preform, it is common to manufacture the core glass rod by installing a core deposition burner that deposits the core portion and a cladding deposition burner that deposits the cladding portion at the same time on an outer side thereof. A product manufactured by the VAD method is a soot body in which soot-like silica fine particles are deposited, and thereafter the soot body is subjected to heat treatment by the heater to remove impurities and to be vitrified into transparent glass, thereby becoming a transparent core glass rod. As necessary, the cladding is further added to an outer periphery of the core glass rod to obtain an optical fiber preform.

Optical characteristics of a single-mode transmission optical fiber include the cutoff wavelength. The cutoff wavelength is the minimum wavelength at which only one mode can propagate, and is important because, in a single-mode transmission fiber, the cutoff wavelength is a boundary at which signal light is transmitted in single mode or transmitted in multimode. Also in ITU-T Recommendation G.652.D, a range of the cutoff wavelength of an optical fiber cable is defined. An optical fiber is generally manufactured by drawing the optical fiber preform. Although the cutoff wavelength of an optical fiber is also affected by fiber drawing conditions, the cutoff wavelength is mainly determined by a refractive index profile of the core portion of the optical fiber, and therefore can be estimated from a refractive index profile of the core glass rod or the optical fiber preform. From the above, it can be said that accurate measurement of the refractive index profile of the optical fiber preform is an important technique for quality control of the optical fiber preform and the optical fiber.

In measurement of the refractive index profile of an optical fiber preform, for example, Non-Patent Document 1 describes, as a refraction angle method, a method for nondestructively measuring the refractive index profile of a rod.

In order to measure the refractive index profile of the optical fiber preform, the following method is employed. First, the optical fiber preform is immersed in matching oil having a refractive index substantially equal to that of the cladding thereof, light is incident perpendicularly to the longitudinal direction of the preform, that is, from a radial direction, and a position of light transmitted through the optical fiber preform is measured. This measurement is continuously performed while moving the light source in the radial direction, the refraction angle of light at each light source position is obtained from a relationship between an incident position of light and a position of transmitted light, and finally a refractive index profile inside the optical fiber preform is calculated.

As a method for measuring the position of transmitted light, there is a method using a detector such as the line sensor in which CCD elements are arranged one-dimensionally. As the light source for irradiating an optical fiber preform, a HeNe laser or the like is used. FIG. 1 is a schematic diagram illustrating an example of the optical system of a refractive index profile measuring apparatus.

Patent Document 1 proposes a method in which transmitted light is projected onto a screen, an image thereof is captured by the line sensor camera, and a position of the transmitted light is calculated by image processing. In this method, since transmitted light is projected onto the line sensor with a certain width, a midpoint of a portion in which a luminance of the light exceeds a preset threshold is used as a position of the transmitted light. According to this method, there is an advantage that the change in the position of transmitted light can be measured precisely.

However, when a local increase in refractive index is present in an optical fiber preform, when light is transmitted through the locally increased position, the transmitted light may be projected with a large spread onto the screen or the line sensor camera. Part of the transmitted light may extend outside the range of the screen or the line sensor camera. In such a case, it is not easy to accurately determine the position of the transmitted light. A phenomenon is observed in which the cutoff wavelength estimated from the refractive index profile of the optical fiber preform having such a local increase in refractive index greatly deviates from an actually measured cutoff wavelength of an optical fiber obtained by actually drawing.

### Related Art Documents

Patent Documents
Patent Document 1: Japanese Unexamined Patent Application Publication No. 2002-62221
Non-Patent Documents
Non-Patent Document 1: Dietrich Marcuse, "Principles of Optical Fiber Measurements", Academic Press (1981)

### Effect of the Invention

According to the present invention, in the optical fiber preform, if a spread of a luminance distribution of transmitted light in a radial direction of the core portion is small, an estimated value of a cutoff wavelength of an optical fiber obtained therefrom has a small deviation from an actually measured value of a cutoff wavelength of an optical fiber obtained by actually drawing, thereby providing a favorable optical fiber preform.

### BRIEF DESCRIPTION OF THE DRAWINGS

FIG. 1 is a schematic diagram illustrating an example of an optical system of a refractive index profile measuring apparatus.

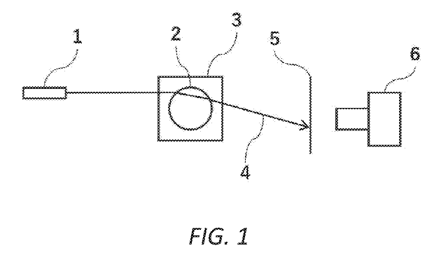

FIG. 2 is a schematic diagram for explaining a state in which a glass fine particle deposit is manufactured by a total of three burners.

FIG. 3 is a schematic diagram illustrating the cross-sectional shape of a cladding portion deposition burner.

FIG. 4 is a diagram illustrating the refractive index profile of the optical fiber preform of Example 1.

FIG. 5 is a diagram illustrating the luminance distribution of light transmitted through a certain radial position when the refractive index profile of the optical fiber preform of Example 1 was measured.

FIG. 6 is a diagram illustrating the refractive index profile of the optical fiber preform of Comparative Example 1.

FIG. 7 is a diagram illustrating the luminance distribution of light transmitted through a radial position where a local increase in refractive index is present when the refractive index profile of the optical fiber preform of Comparative Example 1 was measured.

FIG. 8A is a diagram illustrating, for a part of the optical fiber preform of Example 1 whose refractive index profile is illustrated in FIG. 4, a refractive index profile obtained by the refraction angle method and a refractive index profile estimated from a Ge concentration distribution obtained by an EPMA method.

FIG. 8B is a diagram illustrating, for a part of the optical fiber preform of Comparative Example 1 whose refractive index profile is illustrated in FIG. 6, the refractive index profile obtained by the refraction angle method and the refractive index profile estimated from a Ge concentration distribution obtained by the EPMA method.

### DESCRIPTION OF EXEMPLARY EMBODIMENTS

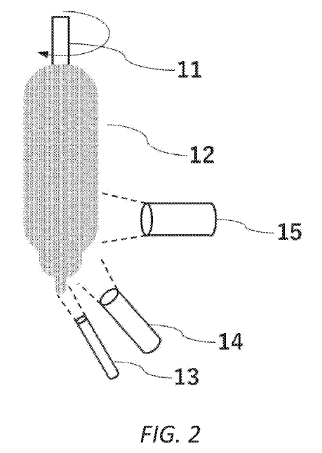

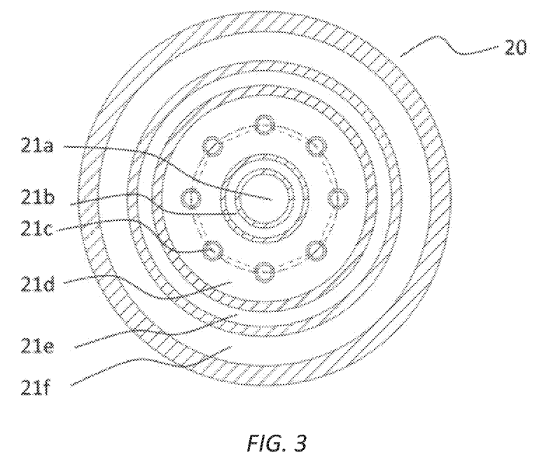

Hereinafter, embodiments of the present invention will be described by way of an example and a comparative example of the present invention with reference to the drawings, but these do not limit the present invention. FIG. 2 shows a state during manufacture of the glass fine particle deposit. The core portion deposition burner 13 depicted at the lowermost position is independent of cladding portion deposition burners 14 and 15 in order to introduce dopant raw materials such as germanium tetrachloride in addition to silicon tetrachloride, and it is often the case that a plurality of burners are arranged as a whole to produce soot. After depositing the core portion located at the center on a starting material 11, a cladding portion is formed so as to cover the core portion from an outer side by the cladding portion deposition burners 14 and 15 arranged above the core portion. FIG. 3 shows cross-sectional shapes of the cladding portion deposition burners 14 and 15.

### Example

Example 1;
As Example 1 of the present invention, the glass fine particle deposit was manufactured under the following conditions using three burners including the core portion deposition burner 13 and the first cladding portion deposition burner 14 and the second cladding portion deposition burner 15.
That is, a concentric four-tube burner was used as the core portion deposition burner 13, and silicon tetrachloride at 0.32 L/min and germanium tetrachloride at 15 mL/min, and argon at 0.19 L/min as the carrier gas were flowed through the center tube. Hydrogen at 6.2 L/min was flowed through the second tube from the center, argon at 0.75 L/min as the seal gas was flowed through the third tube, and oxygen at 10.2 L/min was flowed through the outermost tube.
Silicon tetrachloride at 0.80 L/min and oxygen at 0.66 L/min were flowed through the nozzle 21a of the first cladding portion deposition burner 14. Further, hydrogen at 30 L/min was flowed through the nozzle 21d, oxygen at 18 L/min was flowed through the nozzle 21f, and oxygen at a total of 1.5 L/min was flowed through the small-diameter nozzle group 21c. On the other hand, silicon tetrachloride at 4.8 L/min and oxygen at 3.6 L/min were flowed through the nozzle 21a of the second cladding portion deposition burner 15 under the setting, hydrogen at 65 L/min was flowed through the nozzle 21d, oxygen at 31 L/min was flowed through the nozzle 21f, and oxygen at a total of 6.2 L/min was flowed through the small-diameter nozzle group 21c.

The produced glass fine particle deposit was heated to around 1200°C in the furnace tube containing chlorine gas to perform a dehydration treatment, and then was heated to around 1550°C in the furnace tube containing helium gas to be vitrified into transparent glass, thereby obtaining a core glass rod.

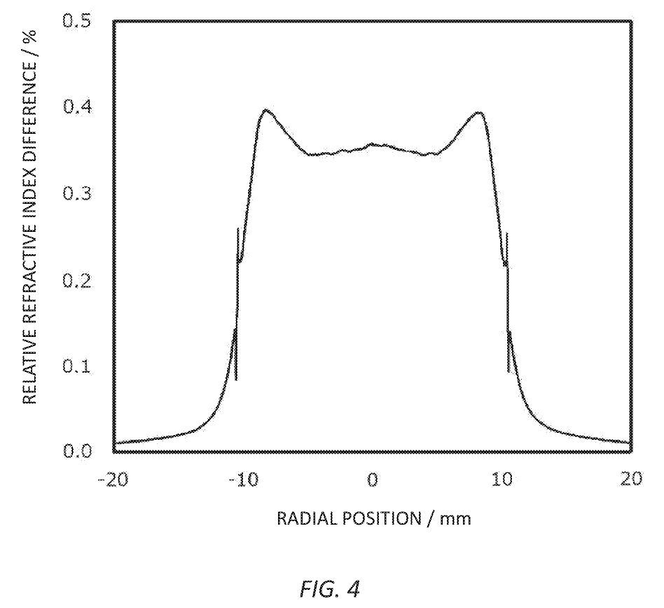

The refractive index profile of the core glass rod obtained in Example 1 was measured by the refraction angle method to obtain FIG. 4. After virtually adding the cladding to the refractive index profile of FIG. 4, estimation calculation of optical characteristics was performed. Further, when the cladding was actually added and the optical fiber was drawn to actually measure the cutoff wavelength of the optical fiber, the deviation between the previously obtained estimated value of the cutoff wavelength and the actually measured value was small.

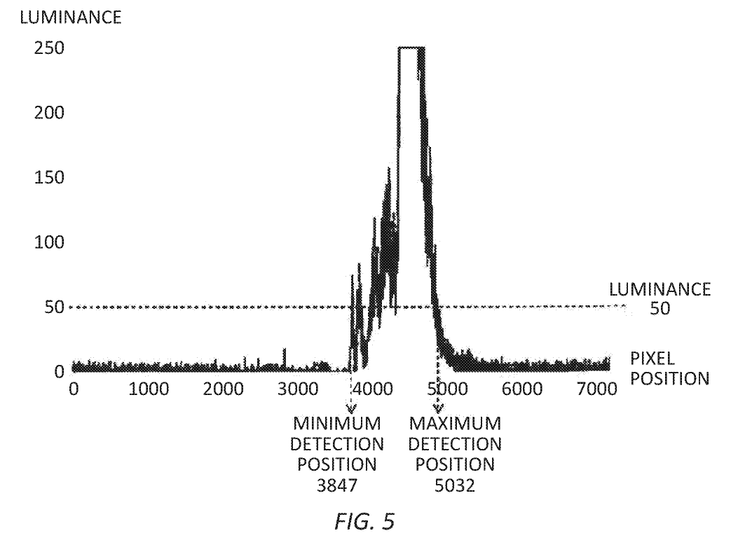

Next, the luminance distribution of the transmitted light measured in the refractive index profile measurement by the refraction angle method is shown in FIG. 5. In FIG. 5, the horizontal axis indicates the position of pixels of the line sensor, corresponding to positions of 0 to 7399 pixels from left to right, and the vertical axis indicates, with a resolution of 0 to 255 levels, the intensity of light detected by each pixel. The pattern thus obtained is referred to as the luminance distribution.

Whether or not the transmitted light in FIG. 5 had the spread was determined as follows. First, with the luminance threshold set to 50, it is determined that the point where the luminance first exceeds 50 from the left of the pixel position, the minimum detected pixel position, is 3847, and the point where the luminance first exceeds 50 from the right of the pixel position, the maximum detected pixel position, is 5032. Therefore, when the interval (5032 - 3847 = 1185) between the maximum detection position and the minimum detection position is defined as the spread width of the transmitted light, since this is below the set width threshold value of 2000, the core glass rod of Example 1 was determined to have a small spread of the transmitted light. The above determination was performed for the luminance distribution obtained by refractive index profile measurement at a certain radial position when obtaining FIG. 4, but also in measurements at other radial positions, similarly, the spread of the transmitted light was small.

Comparative Example 1;
As Comparative Example 1 of the present invention, the glass fine particle deposit was produced under the following conditions using three burners including the core portion deposition burner 13 and the first cladding portion deposition burner 14 and the second cladding portion deposition burner 15.
That is, for the core portion deposition burner 13, the concentric four-tube burner was used, and silicon tetrachloride at 0.36 L/min and germanium tetrachloride at 16 mL/min, and argon at 0.19 L/min as the carrier gas were flowed through the center tube. Hydrogen at 6.5 L/min was flowed through the second tube from the center, argon at 0.75 L/min as the seal gas was flowed through the third tube, and oxygen at 10.2 L/min was flowed through the outermost tube. Silicon tetrachloride at 0.80 L/min and oxygen at 0.66 L/min were flowed through the nozzle 21a of the first cladding portion deposition burner 14. Further, hydrogen at 34 L/min was flowed through the nozzle 21d, oxygen at 18 L/min was flowed through the nozzle 21f, and oxygen at a total of 1.5 L/min was flowed through the small-diameter nozzle group 21c. On the other hand, silicon tetrachloride at 4.8 L/min and oxygen at 3.6 L/min were flowed through the nozzle 21a of the second cladding portion deposition burner 15 under the setting, hydrogen at 65 L/min was flowed through the nozzle 21d, oxygen at 31 L/min was flowed through the nozzle 21f, and oxygen at a total of 6.2 L/min of oxygen was flowed through the small-diameter nozzle group 21c.

The produced glass fine particle deposit was heated to around 1200°C in the furnace tube containing chlorine gas to perform a dehydration treatment, and was thereafter heated to around 1550°C in the furnace tube containing helium gas to be vitrified into transparent glass, thereby obtaining the core glass rod.

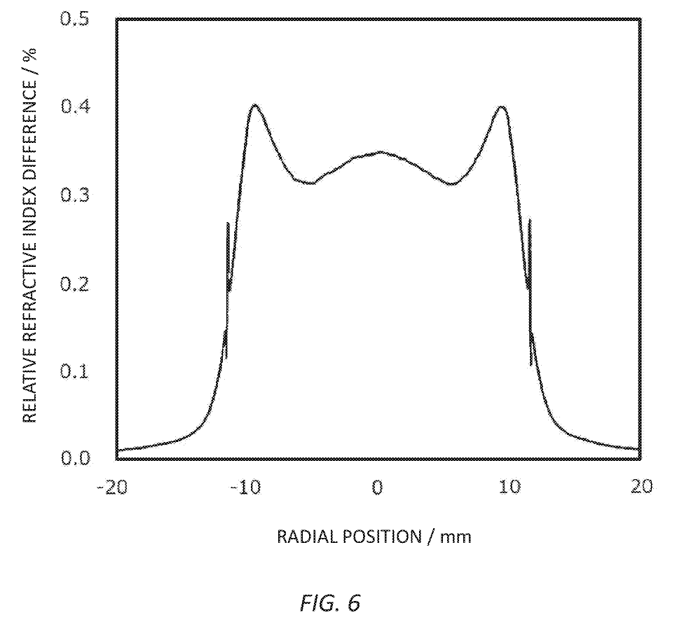

The refractive index profile of the core glass rod obtained in Comparative Example 1 was measured by the refraction angle method to obtain FIG. 6. An estimation calculation of optical characteristics was performed by virtually adding the cladding to the refractive index profile of FIG. 6. In addition, when the cladding was actually added and the resultant was drawn to actually measure the cutoff wavelength of the optical fiber, the actually measured value of the cutoff wavelength became significantly larger than an estimated value obtained by the estimation calculation performed earlier.

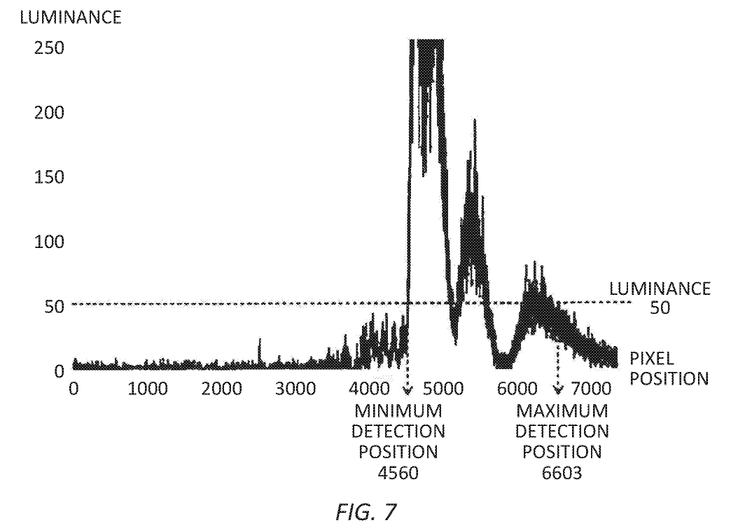

Next, the luminance distribution of the transmitted light at the time of measuring the refractive index profile by the refraction angle method is shown in FIG. 7. It was determined whether or not the transmitted light of FIG. 7 had a spread. First, when the luminance threshold is set to 50, it is found from the figure that the minimum detection position is 4560 and the maximum detection position is 6603. Therefore, when the interval (6603 - 4560 = 2043) between the minimum detection position and the maximum detection position is defined as the spread width of the transmitted light, since this exceeds the set width threshold of 2000, it was determined that the core glass rod of Comparative Example 1 had a large spread of the transmitted light. In the above example and comparative example, the spread of transmitted light was measured in a state of the core glass rod to estimate a cutoff wavelength and a deviation from an actually measured value was examined; however, this similarly applies to the optical fiber preform having an optically same structure.

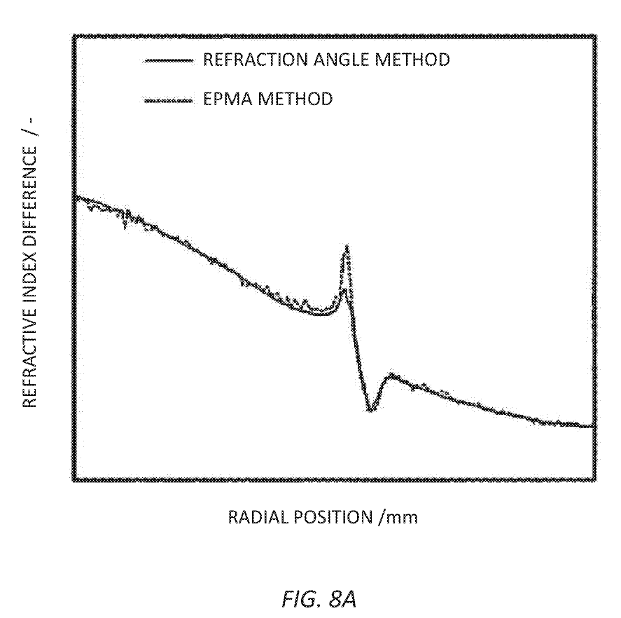

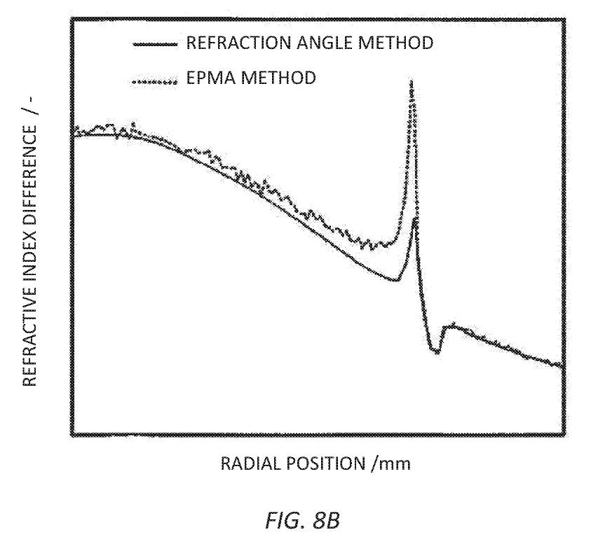

The refractive index profiles of the core glass rods shown in FIGS. 4 and 6 were measured by the refraction angle method as described above. However, when there is the locally high refractive index region, it is difficult to accurately determine the refraction angle because the spread of transmitted light increases, and there is a possibility that the refractive index profile could not be accurately measured. Therefore, quantitative analysis of the Ge atoms, which are up-dopants for the refractive index, was performed by the EPMA (Electron Probe Micro Analyzer) method, and the actual refractive index profile was estimated. The results are shown in FIGS. 8A and FIG. 8B, respectively. FIG. 8A is based on the core glass rod of Example 1, and FIG. 8B is based on Comparative Example 1.

In both FIGS. 8A and FIG. 8B, a difference is observed between the refractive index profile measured by the refraction angle method and the refractive index profile measured by the EPMA method, and it can be seen that, particularly at a location where the refractive index is locally increased, the refractive index difference by the EPMA method is larger than the refractive index difference by the refraction angle method. When FIGS. 8A and FIG. 8B, are compared, in the refraction angle method, FIG. 8B, which had a location where the local increase in refractive index was large, that is, where the spread of the luminance distribution of transmitted light was large, has a larger deviation from the refractive index measured by the EPMA method. That is, when the cutoff wavelength of an optical fiber is estimated from the refractive index profile of FIG. 6 obtained by measuring the core glass rod of Comparative Example 1 by the refraction angle method, the estimated value by the EPMA method was 21 nm larger than the estimated value by the refraction angle method. That is, if there is the radial position having the refractive index that causes the spread of the luminance distribution of transmitted light to increase, there is a risk that the cutoff wavelength when the optical fiber is finally formed may be underestimated.

As described above, when the refractive index profile is measured by the refraction angle method, in the example of Example 1 in which the spread of the luminance distribution of transmitted light is small, the deviation between the cutoff wavelength of the optical fiber estimated from the refractive index profile and the actually measured value is small, whereas in the example of Comparative Example 1 in which the spread of the luminance distribution of transmitted light is large, the deviation between the cutoff wavelength of the optical fiber estimated from the refractive index profile and the actually measured value is large. Therefore, it can be said that, as the index of a local increase in refractive index, suppressing the spread of the luminance distribution of transmitted light is useful for improving estimation accuracy of a cutoff wavelength of a core glass rod.

### EXPLANATION OF REFERENCES

1: light source; 2: optical fiber preform; 3: cell; 4: transmitted light; 5: screen; 6: line sensor camera; 11: starting material; 12: glass fine particle deposit; 13: core deposition burner; 14: first cladding portion deposition burner; 15: second cladding portion deposition burner; 20: burner; 21a: innermost gas ejection port; 21b: second gas ejection port from the inside; 21c: small-diameter nozzle group in the third gas ejection region from the inside; 21d: third gas ejection port from the innermost side; 21e: fourth gas ejection port from the inside; and 21f: fifth gas ejection port from the inside.

What is claimed is:

1. An optical fiber preform comprising a core portion with a relatively high refractive index and a cladding portion with a relatively low refractive index, wherein in a luminance distribution of transmitted light projected, when laser light is incident on the optical fiber preform to be scanned in a radial direction of the optical fiber preform from one end to another end, on a screen or on a line sensor camera installed to face a light source of laser light with the optical fiber preform interposed therebetween, a width of a luminance distribution exceeding a set luminance threshold does not exceed a set width threshold.
